(19) United States
(12) Patent Application Publication
(10) Pub. No.: US 2024/0194989 A1
(43) Pub. Date: Jun. 13, 2024

(54) BUTTON-TYPE SECONDARY BATTERY AND METHOD FOR MANUFACTURING THE SAME

(71) Applicant: LG ENERGY SOLUTION, LTD., Seoul (KR)

(72) Inventors: Min Su CHO, Daejeon (KR); Byung Sup KIM, Daejeon (KR); Joo Hwan SUNG, Daejeon (KR); Yong Gon LEE, Daejeon (KR); Geun Young PARK, Daejeon (KR); Min Gyu KIM, Daejeon (KR); Min Seon KIM, Daejeon (KR); Yeong Hun JUNG, Daejeon (KR); Sang Hak CHAE, Daejeon (KR)

(73) Assignee: LG ENERGY SOLUTION, LTD., Seoul (KR)

(21) Appl. No.: 17/782,565

(22) PCT Filed: Jul. 1, 2021
(86) PCT No.: PCT/KR2021/008376

§ 371 Date: Jun. 3, 2022

(30) Foreign Application Priority Data
Jul. 1, 2020 (KR) 10-2020-0081088
Jul. 1, 2021 (KR) 10-2021-0086300

(51) Int. Cl. H01M 50/166; H01M 10/04; H01M 50/109; H01M 50/153; H01M 50/184; H01M 50/186

(52) U.S. Cl. CPC H01M 50/166; H01M 10/0427; H01M 50/109; H01M 50/153; H01M 50/184; H01M 50/186

(57) ABSTRACT

A button-type secondary battery includes: a lower can configured to operate as a first electrode terminal; an upper can coupled to the lower can to surround the lower can and configured to operate as a second electrode terminal; and a gasket between the lower can and the upper can. A recessed lower insertion groove and a recessed upper insertion groove are defined in a surface of the lower can and a surface of the upper can, which are in close contact with the gasket, respectively. The lower insertion groove and the upper insertion groove are spaced apart from each other so as not to face each other.

### CROSS-REFERENCE TO RELATED APPLICATION

The present application claims the benefit of the priority of Korean Patent Application Nos. 10-2020-0081088, filed on Jul. 1, 2020, and 10-2021-0086300, filed on Jul. 1, 2021, which are hereby incorporated by reference in their entirety.

### TECHNICAL FIELD

The present invention relates to a button-type secondary battery and a method for manufacturing the same, and more particularly, to a button-type secondary battery in which coupling and adhesion between a lower can and an upper can increase through a gasket, and a method for manufacturing the same.

### BACKGROUND ART

In general, secondary batteries refer to chargeable and dischargeable, unlike primary batteries that are not chargeable. The secondary batteries are being widely used for mobile phones, notebook computers, and camcorders, electric vehicles, and the like.

The secondary battery comprises a button-type secondary battery having high energy density, high output, and long lifespan. The button-type secondary battery comprises an electrode assembly, a lower can accommodating the electrode assembly, an upper can coupled to the lower can, and a gasket sealing the lower can and the upper can.

However, in the button-type secondary battery, if fitting force is high when the lower can and the upper can are coupled to each other, the gasket is damaged, and if coupling force and adhesion between the lower can and the upper can decrease, and the fitting force is weak, the gasket is prevented from being damaged, but there is a problem in that the coupling force and adhesion between the lower can and the upper can decrease due to weakening in sealing force between the lower can and the upper can.

### DISCLOSURE OF THE INVENTION

### Technical Problem

The present invention is invented to solve the above problems, and an object of the present invention is to provide a button-type secondary battery in which structures of a lower can and an upper can are improved to increase in coupling force and adhesion between the lower can and the upper can through a gasket and also to prevent the gasket from being damaged, and a method for manufacturing the same.

### Technical Solution

A button-type secondary battery according to the present invention for achieving the above object comprises: a lower can serving as a first electrode terminal; an upper can coupled to surround the lower can and serving as a second electrode terminal; and a gasket provided between the lower can and the upper can, wherein a recessed lower insertion groove and a recessed upper insertion groove are formed in a surface of the lower can and a surface of the upper can, which are in close contact with the gasket, respectively, and the lower insertion groove and the upper insertion groove are spaced apart from each other so as not to face each other.

A portion of the gasket may be introduced into the lower insertion groove and the upper insertion groove by clamping of the lower can and the upper can to form a lower insertion protrusion and an upper insertion protrusion on a surface of the gasket, a contact area between the lower can and the gasket may increase by the lower insertion protrusion, and a contact area between the upper can and the gasket may increase by the upper insertion protrusion.

The lower insertion groove or the upper insertion groove may have a triangular shape that gradually decreases in width toward the bottom.

The lower insertion groove or the upper insertion groove may be provided in two or more, and the two or more lower insertion grooves or the two or more upper insertion grooves may be provided to be connected to each other in a direction in which the lower can and the upper can are clamped.

The two or more lower insertion grooves or the two or more upper insertion grooves may be provided to increase in size in the direction in which the lower can and the upper can are clamped.

The gasket may comprise an outer part provided between the lower can and the upper can, an inner part supported on an inner wall of the lower can, and a connection part configured to connect an upper end of the outer part to an upper end of the inner part.

A pressing protrusion configured to press the gasket provided between the lower can and the upper can may be formed on the lower can.

A method for manufacturing a button-type secondary battery comprises: a preparation process of preparing a lower can having a recessed lower insertion groove, an upper can having a recessed upper insertion groove, and a gasket disposed between the lower can and the upper can; an accommodation process of accommodating an electrode assembly, in which a first electrode, a separator, and a second electrode are alternately stacked, in the lower can; a disposition process of disposing the gasket on an upper portion of the lower can, wherein the gasket comprises an outer part supported on an outer circumferential surface of the lower can, an inner part supported on an inner circumferential surface of the lower can, and a connection part connecting the outer part to the inner part; and a clamping process of disposing the upper can on an upper portion of the lower can to clamp the lower can and the upper can, thereby manufacturing the button-type secondary battery, wherein, in the preparation process, the lower insertion groove formed in the lower can and the upper insertion groove formed in the upper can are disposed to be spaced apart from each other so as not to face each other when the lower can and the upper can are coupled to each other.

In the clamping process, when the lower can and the upper can are clamped, a portion of the gasket may be introduced into the lower insertion groove and the upper insertion groove form a lower insertion protrusion and an upper insertion protrusion on a surface of the gasket, a contact area between the lower can and the gasket may increase by the lower insertion protrusion, and a contact area between the upper can and the gasket may increase by the upper insertion protrusion.

The lower insertion groove or the insertion groove of the upper can may have a triangular shape that gradually decreases in width toward the bottom.

In the preparation process, the lower insertion groove or the upper insertion groove may be provided in two or more, and the two or more lower insertion grooves or the two or more upper insertion grooves may be formed to be connected to each other in a direction in which the lower can and the upper can are clamped.

In the preparation process, a pressing protrusion pressing the gasket may be formed on the lower can below the lower insertion groove, and in the clamping process, when the lower can and the upper can are clamped, since a lower portion of the gasket is fixed by the pressing protrusion, the gasket may be introduced into the lower insertion groove and the upper insertion groove while being expanded in a direction of the upper can and the lower can.

### Advantageous Effects

In the button-type secondary battery of the present invention, the recessed lower insertion groove and the recessed upper insertion groove may be formed in the lower can and the upper can, which are in close contact with the gasket, respectively. Here, the lower insertion groove and the upper insertion groove may be disposed to be spaced apart from each other so as not to face each other. Therefore, when the lower can and the upper can are clamped, a portion of the gasket may be introduced into each of the lower insertion groove and the upper insertion groove to form each of the lower insertion protrusion and the upper insertion protrusion on the surface of the gasket, thereby preventing the gasket from being damaged, and as a result, the adhesion and the coupling force between the lower can and the upper can may increase.

In addition, in the button-type secondary battery of the present invention, the lower insertion groove or the upper insertion groove may have the triangular shape that gradually decreases in width toward the bottom. Therefore, the gasket may be stably introduced into the entire lower insertion groove and the entire upper insertion groove, and as a result, the adhesion and the coupling force between the lower can and the upper can may increase.

In addition, in the button-type secondary battery of the present invention, the two or more lower insertion grooves or the two or more upper insertion grooves may be provided to be connected to each other. Therefore, the two or more lower insertion protrusions and two or more upper insertion protrusions may be formed on the surface of the gasket.

In addition, in the button-type secondary battery of the present invention, the pressing protrusion for pressing the gasket may be formed on the lower can below the lower insertion groove. Therefore, the fixing force of the gasket may increase, and thus, a portion of the gasket may be smoothly inserted into each of the lower insertion groove and the upper insertion groove, and as a result, the insertion protrusion may be effectively formed on the surface of the gasket.

### BRIEF DESCRIPTION OF THE DRAWINGS

FIG. 1 is an exploded perspective view of a button-type secondary battery according to a first embodiment of the present invention.

FIG. 2 is an assembly cross-sectional view of the button-type secondary battery according to the first embodiment of the present invention.

FIG. 3 is a cross-sectional view illustrating another example of lower and upper insertion grooves in the button-type secondary battery according to the first embodiment of the present invention.

FIG. 4 is a flowchart illustrating a method for manufacturing a button-type secondary battery according to the first embodiment of the present invention.

FIG. 5 is a cross-sectional view illustrating a preparation process in the method for manufacturing the button-type secondary battery according to the first embodiment of the present invention.

FIG. 6 is a cross-sectional view illustrating an accommodation process in the method for manufacturing the button-type secondary battery according to the first embodiment of the present invention.

FIG. 7 is a cross-sectional view illustrating a disposition process in the method for manufacturing the button-type secondary battery according to the first embodiment of the present invention.

FIG. 8 is a cross-sectional view illustrating a clamping process in the method for manufacturing the button-type secondary battery according to the first embodiment of the present invention.

FIG. 9 is a cross-sectional view of a button-type secondary battery according to a second embodiment of the present invention.

FIG. 10 is a cross-sectional view of a button-type secondary battery according to a third embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### Button-Type Secondary Battery According to First Embodiment of the Present Invention

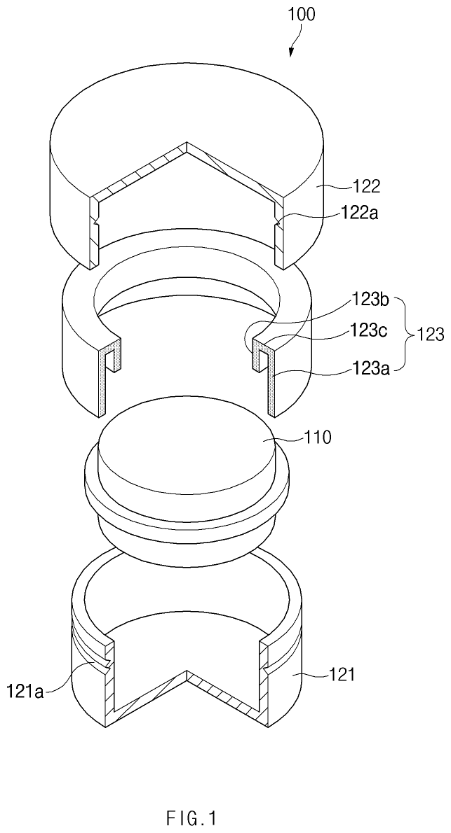

As illustrated in FIGS. 1 to 3, a button-type secondary battery 100 according to a first embodiment of the present invention is a secondary battery, of which a length of a diameter is greater than a height, and comprises an electrode assembly 110 and a can assembly 120 accommodating the electrode assembly 110.

The button-type secondary battery is referred as a coin cell, also referred to as a Ruben battery, an RM battery, and a mercury battery. Such a button-type secondary battery may be made small and thus be widely used in hearing aids, portable lighters, wireless microphones, cameras, watches, and the like. Also, zinc is used for a negative electrode, and mercury oxide is used for a positive electrode. In addition, zinc oxide and potassium hydroxide are used for an electrolyte.

### Electrode Assembly

The electrode assembly 110 has a three-layered structure in which a first electrode, a separator, and a second electrode are sequentially stacked. The electrode assembly is not limited to the three-layered structure and may have a three or more-layered structure in which a first electrode and a second electrode are alternately stacked with a separator interposed therebetween.

Here, the separator is formed to be larger than each of the first electrode and the second electrode, and thus, the separator prevents the first electrode and the second electrode from being grounded, and as a result, an accident due to short circuit is prevented. The first electrode is a negative electrode, and the second electrode is a positive electrode.

### Can Assembly

The can assembly 120 comprises a lower can 121 connected to a first electrode of the electrode assembly 110 and serving as a first electrode terminal, an upper can 122 connected to a second electrode of the electrode assembly 110, coupled to surround the lower can 121, and serving as a second electrode terminal, and a gasket 123 provided between the lower can 121 and the upper can 122 to insulate the lower can and the upper can from each other.

The button-type secondary battery 100 according to the first embodiment of the present invention has a structure, in which adhesion and coupling force between the lower can 121 and the upper can 122 increase.

That is, the lower can 121 has a recessed lower insertion groove 121a in a surface thereof, which is in close contact with the gasket 123, and the upper can 122 has a recessed upper insertion groove 122a in a surface thereof, which is in close contact with the gasket 123.

Here, the lower insertion groove 121a and the upper insertion groove 122a are disposed to be spaced apart from each other so as not to face each other when viewed in a state in which the lower can 121 and the upper can 122 are coupled to each other.

Thus, a portion of the gasket 123 is introduced (i.e., inserted) into the lower insertion groove 121a and the upper insertion groove 122a by clamping the lower can 121 and the upper can 122 to form a lower insertion protrusion 123a-1 and an upper insertion protrusion 123a-2 on a surface of the gasket 123, respectively. As a result, a contact area between the lower can 121 and the gasket 123 may increase by the lower insertion protrusion 123a-1 to increase in adhesion and coupling force. In addition, a contact area between the upper can 122 and the gasket 123 may increase by the upper insertion protrusion 123a-2 to increase in adhesion and coupling force.

The clamping refers to press-fitting or clamping two objects.

In more detail, the gasket 123 is disposed on an upper portion of the lower can 121, and then the upper can 122 is disposed on an upper portion of the gasket 123. Next, the upper can 122 is pressed in a direction of the lower can 121 to bond the upper can 122 and the lower can 121 to each other. Here, while the gasket 123 disposed between the upper can 122 and the lower can 121 is compressed, a portion of the gasket 123 is introduced into the lower insertion groove 121a and the upper insertion groove 122a. Thus, a lower insertion protrusion 123a-1 and an upper insertion protrusion 123a-2 are formed on the surface of the gasket 123.

Particularly, the lower insertion groove 121a and the upper insertion groove 122a are disposed in the lower can 121 and the upper can 122 and spaced apart from each other so as not to face each other. Thus, the lower insertion protrusion 123a-1 and the upper insertion protrusion 123a-2 formed on the surface of the gasket 123 are spaced apart from each other so as not to face each other. As a result, an amount of insertion of the gasket 123, which is inserted into each of the lower insertion groove 121a and the upper insertion groove 122a, may be sufficiently secured. Thus, since the amount of insertion of the gasket, which is inserted into the lower insertion groove 121a and the upper insertion groove 122a, is sufficiently secured, the lower insertion protrusion 123a-1 and the upper insertion protrusion 123a-2 may be stably formed, and as a result, the adhesion and the coupling force between the lower can 121 and the upper can 122 may increase.

Here, the lower insertion protrusion 123a-1 may be provided to adhere to the lower insertion groove 121a, and the upper insertion protrusion 123a-2 may be provided to adhere to the upper insertion groove 122a. For example, the lower insertion protrusion 123a-1 may adhere to the lower insertion groove 121a through an adhesive, and the upper insertion protrusion 123a-2 may adhere to the upper insertion groove 122a through an adhesive. Thus, the coupling force between the lower insertion protrusion 123a-1 and the lower insertion groove 121a may increase, and the coupling force between the upper insertion protrusion 123a-2 and the upper insertion groove 122a may increase.

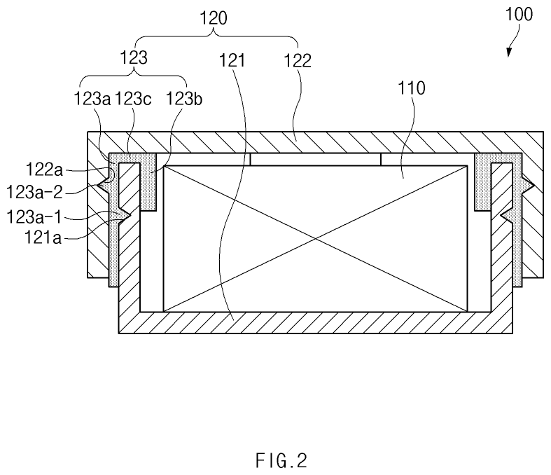

As another example of the button-type secondary battery 100 according to the first embodiment of the present invention, the upper insertion groove 122a may have an area greater than that of the lower insertion groove 121a. That is, referring to FIG. 2, a contact area between the upper can 122 and the gasket 123 is less than that between the lower can 121 and the gasket 123. Thus, the upper insertion groove 122a is formed to be larger than the lower insertion groove 121a to increase in contact area between the upper can 122 and the gasket 123, thereby preventing an electrode from leaking.

As another example of the button-type secondary battery 100 according to the first embodiment of the present invention, the lower insertion groove 121a or the upper insertion groove 122a may have a triangular shape of which a width gradually decreases toward the bottom. That is, the amount of insertion of the gasket 123 gradually decreases toward the bottom of the lower insertion groove 121a or the upper insertion groove 122a. Thus, the lower insertion groove 121a or the upper insertion groove 122a may be formed in the triangular shape, and thus, the amount of insertion of the gasket 123 may be stably secured up to the bottom of the lower insertion groove 121a or the upper insertion groove 122a. As a result, the insertion protrusions 123a-1 and 123a-2 may be stably formed on the surface of the gasket.

The lower insertion groove 121a or the upper insertion groove 122a may be formed in a semicircular shape that gradually decreases in width toward the bottom.

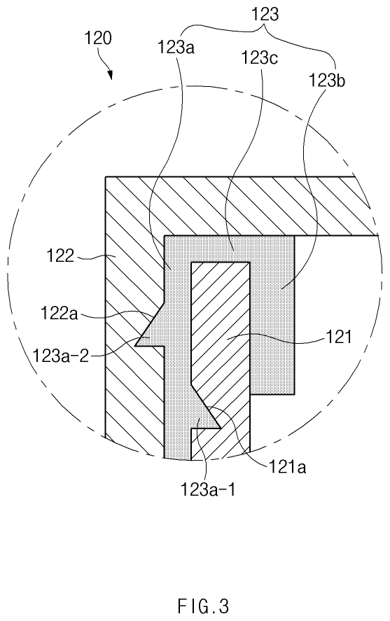

Here, the lower insertion groove 121a or the upper insertion groove 122a may be formed in the form of a right-angled triangle in which an inner wall facing the lower can 121 is horizontal when viewed in FIG. 3. Thus, each of the insertion protrusions 123a-1 and 123a-2 formed on the gasket 123 may also be formed in the form of a right-angled triangle. That is, when clamping the lower can 121 and the upper can 122, a portion of the gasket may be caught in the lower insertion groove 121a or the horizontal inner wall of the upper insertion groove 122a, and thus, the amount of insertion of the gasket, which is inserted into the lower insertion groove 121a or the upper insertion groove 122a, may be sufficiently secured, and as a result, the insertion protrusion may be smoothly formed on the surface of the gasket.

In the button-type secondary battery 100 according to the first embodiment of the present invention, the gasket 123 comprises an outer part 123a provided between the lower can 121 and the upper can 122, an inner part 123b supported on the inner wall of the lower can 121, and a connection part 123c connecting an upper end of the outer part 123a to an upper end of the inner part 123b. Here, the upper insertion protrusion 123a-2 and the lower insertion protrusion 123a-1 are formed on both surfaces of the outer portion 123a, respectively. Thus, the adhesion between the gasket 123 and the lower can 121 and between the gasket 123 and the upper can 122 may increase, and as a result, the electrolyte nay be significantly prevented from leaking.

The inner part 123b is supported on the inner wall of the lower can 121 to prevent the electrode assembly 110 from being in contact with the inner wall of the lower can 121.

Therefore, in the button-type secondary battery 100 according to the first embodiment of the present invention, the recessed lower insertion groove 121a and the recessed upper insertion groove 122a are formed in the lower can 121 and the upper can 122, respectively. Here, the lower insertion groove 121a and the upper insertion groove 122a are disposed to be spaced apart from each other so as not to face each other. When the lower can 121 and the upper can 122 are clamped, a portion of the gasket 123 may be introduced into each of the lower insertion groove 121a and the upper insertion groove 122a to form an insertion protrusion 123a, and the adhesion and the coupling force between the lower can 121 and the upper can 122 may increase through the insertion protrusion 123a.

Hereinafter, a method for manufacturing a button-type secondary battery according to a first embodiment of the present invention will be described.

### Method for Manufacturing Button-Type Secondary Battery According to First Embodiment of the Present Invention

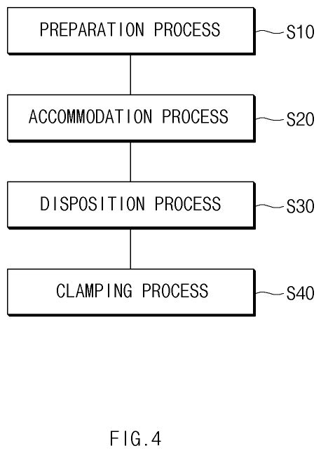

As illustrated in FIGS. 4 to 8, a method for manufacturing a button-type secondary battery according to the first embodiment of the present invention includes a preparation process (S10), an accommodation process (S20), a disposition process (S30), and a clamping process (S40).

### Preparation Process

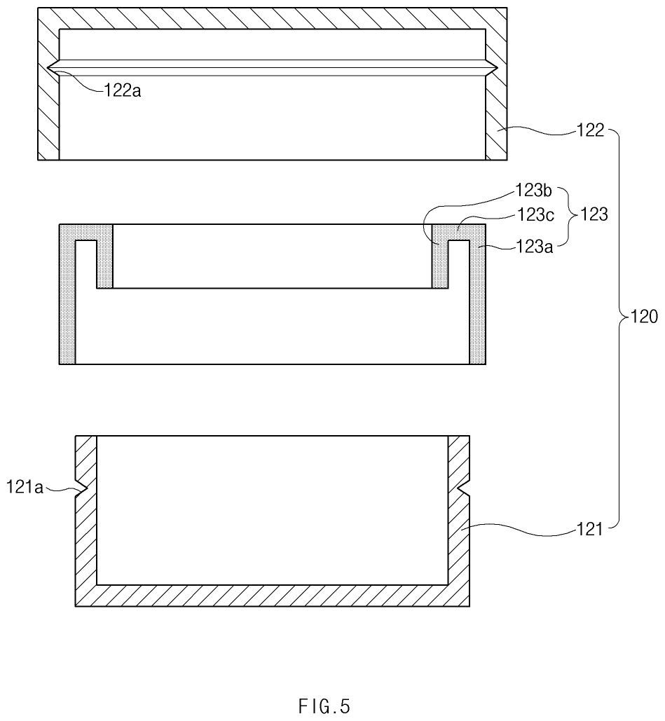

In the preparation process (S10), referring to FIG. 5, a lower can 121, an upper can 122, and a gasket 123 disposed between the lower can 121 and the upper can 122 are prepared.

The lower can 121 has an accommodation groove, which accommodates an electrode assembly in a top surface thereof, and a recessed lower insertion groove 121a in an outer circumferential surface thereof. Particularly, a lower insertion groove 121a is formed along a circumferential surface of the lower can 121, and then both ends of the lower insertion groove 121a are connected to each other.

The upper can 122 has a coupling groove, into which the lower can is coupled to be inserted, in a bottom surface thereof and a recessed upper insertion groove 122a in an inner circumferential surface of the upper can 122, i.e., a wall surface of the coupling groove. Particularly, an upper insertion groove 122a is formed along a circumferential surface of the upper can 122, and then both ends of the lower insertion groove 121a are connected to each other.

The gasket 123 comprises an outer part 123a provided between the lower can 121 and the upper can 122, an inner part 123b disposed on the inner wall of the lower can 121, and a connection part 123c connecting an upper end of the outer part 123a to an upper end of the inner part 123b.

The lower insertion groove 121a formed in the lower can 121 and the upper insertion groove 122a formed in the upper can 122 are spaced apart from each other so as not to face each other That is, referring to FIG. 5, the lower insertion groove 121a is disposed at a lower side, and the upper insertion groove 122a is formed to be disposed above the lower insertion groove 121a so that the lower insertion groove 121a and the upper insertion groove 122a are spaced apart so as not to face each other.

Particularly, each of the lower insertion groove 121a and the upper insertion groove 122a is formed in a triangular shape. Thus, when the lower can 121 and the upper can 122 are clamped, a portion of the gasket 123 disposed between the lower can 121 and the upper can 122 may be induced to be smoothly introduced up to the bottom of each of the lower insertion groove 121a and the upper insertion groove 122a. That is, an amount of insertion of the gasket inserted into the lower insertion groove 121a and the upper insertion groove 122a may be sufficiently secured.

In addition, inner surfaces of the lower insertion groove 121a and the upper insertion groove 122a facing the upper can 122 are formed as a horizontal plane perpendicular to a direction in which the upper can 122 is clamped, and an inner surface facing the lower can 121 is formed as an inclined surface. That is, when the lower can 121 and the upper can 122 are clamped, a portion of the gasket 123 may be guided along the inclined surface and then smoothly introduced up to the bottom of each of the lower insertion groove 121a and the upper insertion groove 122a. In addition, when clamping of the lower can 121 and the upper can 122 is completed, the coupling between the lower can 121 and the upper can 122 may be improved through a portion of the gasket, which is supported on the horizontal plane.

### Accommodation Process

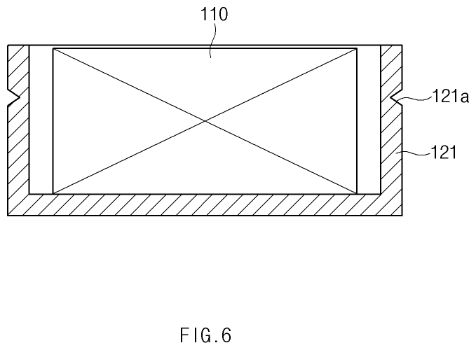

In the accommodation process (S20), referring to FIG. 6, the electrode assembly 110 in which the first electrode, the separator, and the second electrode are alternately stacked is accommodated in an accommodation groove of the lower can 121.

### Disposing Process

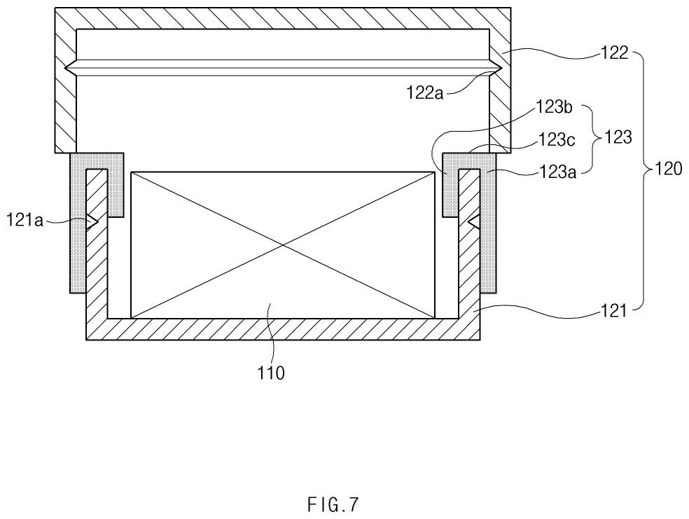

In the disposition process (S30), referring to FIG. 7, the gasket 123 is disposed on the lower can 121. Then, the outer part 123a of the gasket 123 is supported on the outer circumferential surface of the lower can 121, the inner part 123b is supported on the inner circumferential surface of the lower can 121, and the connection part 123c is supported on an upper end of the lower can 121.

### Clamping Process

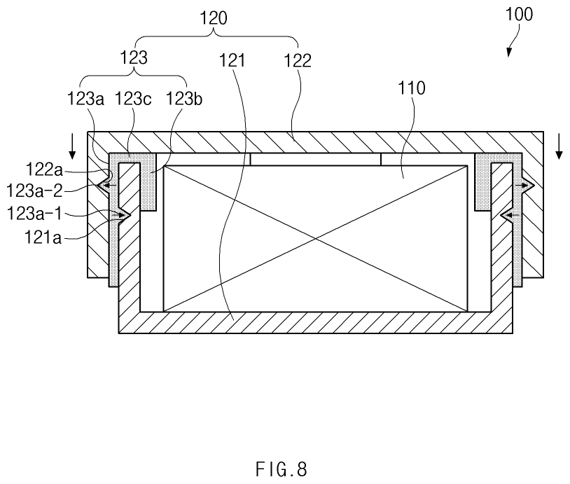

Referring to FIG. 8, in the clamping process (S40), the upper can 122 is disposed on the lower can 121, and then, the lower can 121 and the upper can 122 are clamped. That is, the button-type secondary battery 100 is manufactured by rolling the lower can 121 and the upper can 122 to be coupled to each other.

Here, when the lower can 121 and the upper can 122 are clamped, a portion of the gasket 123 is inserted into each of the lower insertion groove 121a and the upper insertion groove 122a, and thus, each of a lower insertion protrusion 123a-1 and an upper insertion protrusion 123a-2 is formed on the surface of the gasket 123. Here, the insertion protrusion has the same triangular shape as the lower insertion groove 121a and the upper insertion groove 122a. Thus, the coupling force and adhesion between the lower can 121 and the upper can 122 may increase.

That is, a contact area between the lower can 121 and the gasket 123 may increase by the lower insertion protrusion 123a-1 to increase in adhesion and bonding force. In addition, a contact area between the upper can 122 and the gasket 123 may increase by the upper insertion protrusion 123a-2 to increase in adhesion and coupling force.

Therefore, the method for manufacturing the button-type secondary battery according to the first embodiment of the present invention may manufacture the button-type secondary battery 100, in which the coupling force and the adhesion increase.

Hereinafter, in descriptions of another embodiment of the present invention, constituents having the same function as the above-mentioned embodiment have been given the same reference numeral in the drawings, and thus duplicated description will be omitted.

### Button-Type Secondary Battery According to Second Embodiment of the Present Invention

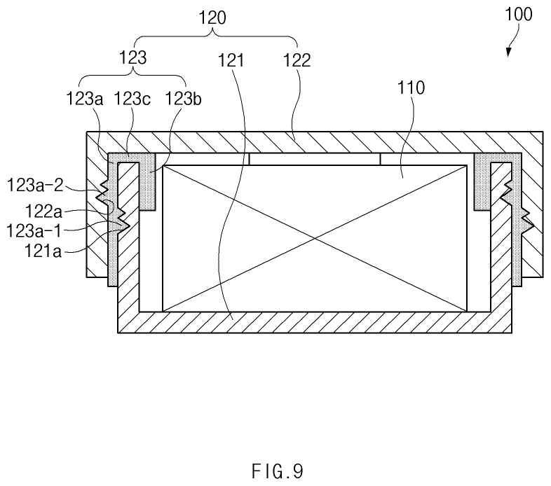

As illustrated in FIG. 9, a button-type secondary battery 100 according to a second embodiment of the present invention has a lower can 121 having a lower insertion groove 121a formed in an outer circumferential surface thereof, and an upper can 122 having an upper insertion groove 122a in an inner circumferential surface thereof.

Here, the lower insertion groove 121a or the upper insertion groove 122a is provided in two or more, and the two or more lower insertion grooves 121a or the two or more upper insertion grooves 122a has a structure in which the lower can 121 and the upper can 122 are connected to each other in a direction in which the lower can 121 and the upper can 122 are clamped. That is, the two or more lower insertion grooves 121a or the two or more upper insertion grooves 122a are provided to be connected to each other in a vertical direction as illustrated in FIG. 9.

Thus, in the button-type secondary battery 100 according to the second embodiment of the present invention, when the lower can 121 and the upper can 122 are clamped, a portion of the gasket 123 may be introduced into the two or more lower insertion grooves 121a or the two or more upper insertion grooves 122a to form two or more insertion protrusions 123a-1. Thus, coupling force and adhesion between the lower can 121 and the upper can 122 may significantly increase.

Each of the two or more lower insertion grooves 121a or the two or more upper insertion grooves 122a gradually increases in size in the direction in which the lower can 121 and the upper can 122 are clamped (a downward direction when viewed in FIG. 9). Of course, the two or more lower insertion grooves 121a and the two or more upper insertion grooves 122a are spaced apart from each other so as not to face each other. Thus, a portion of the gasket 123 may be induced to be smoothly introduced into the two or more lower insertion grooves 121a or the two or more upper insertion grooves 122a.

In the method for manufacturing the button-type secondary battery, which has such a structure, according to the second embodiment of the present invention, in the preparation process, the lower insertion groove 121a or the upper insertion groove 122a is provided in two or more in the lower can 121 and the upper can 122. Particularly, the two or more lower insertion grooves 121a or two or more of the upper insertion grooves 122a are connected to each other in a direction, in which the lower can 121 and the upper can 121 are clamped, and are formed to gradually increase in size.

In addition, when the lower can 121 and the upper can 122 are clamped in the clamping process, a portion of the gasket 123 is introduced into the two or more lower insertion grooves 121a or the two or more upper insertion grooves 122a to form two or more insertion protrusions 123a. Since the two or more insertion protrusions are formed, coupling force and adhesion between the lower can 121 and the upper can 122 significantly increase.

### Button-Type Secondary Battery According to Third Embodiment of the Present Invention

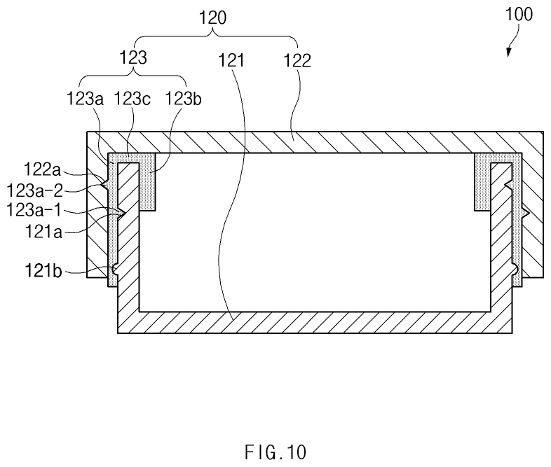

As illustrated in FIG. 10, a button-type secondary battery 100 according to a third embodiment of the present invention comprises a lower can 121, an upper can 122, and a gasket 123. Here, the lower can 121 comprises a lower insertion groove 121a in an outer circumferential surface thereof and a pressing protrusion 121b below the lower insertion groove 121a.

Here, the pressing protrusion 121b presses a surface of the gasket 123 provided between the lower can 121 and the upper can 122 to increase in fixing force of the gasket 123. Thus, when the can 121 and the upper can 122 are clamped, the gasket may be prevented from being tensioned by the pressing protrusion to sufficiently ensure an amount of insertion of the gasket 123 introduced into the lower insertion groove 121a and the upper insertion groove 122a.

At least one or more, preferably, three or more pressing protrusions may be provided on the outer circumferential surface of the lower can. The outer circumferential surface of the pressing protrusion may be coated with a protective layer made of a synthetic resin material for preventing the gasket from being damaged. The pressing protrusion may be formed in a semicircular shape to prevent damage to the gasket.

Therefore, the button-type secondary battery 100 according to the third embodiment of the present invention comprises the pressing protrusion 121b on the lower can 121. Thus, when the lower can 121 and the upper can 122 are clamped, a portion of the gasket 123 may be compressed so that a portion of the gasket 123 is more smoothly introduced into the lower insertion groove 121a and the upper insertion groove 122a, and a result, coupling force and adhesion between the lower can 121 and the upper can 122 may increase.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

100: Button-type secondary battery
110: Electrode assembly
120: Can assembly
121: Lower can
122: Upper can
123: Gasket

1. A button-type secondary battery comprising:
a lower can configured to operate as a first electrode terminal;
an upper can coupled to the lower can to surround the lower can and configured to operate as a second electrode terminal; and
a gasket between the lower can and the upper can,
wherein a recessed lower insertion groove and a recessed upper insertion groove are defined in a surface of the lower can and a surface of the upper can, which are in close contact with the gasket, respectively, and
wherein the lower insertion groove and the upper insertion groove are spaced apart from each other so as not to face each other.

2. The button-type secondary battery of claim 1, wherein a portion of the gasket is introduced into the lower insertion groove and the upper insertion groove by clamping of the lower can and the upper can to form a lower insertion protrusion and an upper insertion protrusion on a surface of the gasket,
a contact area between the lower can and the gasket increases by the lower insertion protrusion, and
a contact area between the upper can and the gasket increases by the upper insertion protrusion.

3. The button-type secondary battery of claim 1, wherein one of the lower insertion groove and the upper insertion groove has a cross-section having a triangular shape that gradually decreases in width toward the bottom.

4. The button-type secondary battery of claim 1, wherein the lower insertion groove or the upper insertion groove is provided in two or more, and
the two or more lower insertion grooves or the two or more upper insertion grooves are provided to be connected to each other in a direction in which the lower can and the upper can are clamped.

5. The button-type secondary battery of claim 4, wherein the two or more lower insertion grooves or the two or more upper insertion grooves are provided to increase in size in the direction in which the lower can and the upper can are clamped.

6. The button-type secondary battery of claim 1, wherein the gasket comprises an outer part provided between the lower can and the upper can, an inner part supported on an inner wall of the lower can, and a connection part configured to connect an upper end of the outer part to an upper end of the inner part.

7. The button-type secondary battery of claim 1, wherein a pressing protrusion configured to press the gasket provided between the lower can and the upper can is disposed on the lower can.

8. A method for manufacturing a button-type secondary battery, the method comprising:
preparing a lower can having a recessed lower insertion groove, an upper can having a recessed upper insertion groove, and a gasket disposed between the lower can and the upper can;
accommodating an electrode assembly, in which a first electrode, a separator, and a second electrode are alternately stacked, in the lower can;
disposing the gasket on an upper portion of the lower can, wherein the gasket comprises an outer part supported on an outer circumferential surface of the lower can, an inner part supported on an inner circumferential surface of the lower can, and a connection part connecting the outer part to the inner part; and
clamping the upper can with the lower can by disposing the upper can on an upper portion of the lower can, thereby manufacturing the button-type secondary battery,
wherein, in the preparation process, the lower insertion groove formed in the lower can and the upper insertion groove formed in the upper can are disposed to be spaced apart from each other so as not to face each other when the lower can and the upper can are coupled to each other.

9. The method of claim 8, wherein, in the clamping, when the lower can and the upper can are clamped, a portion of the gasket is introduced into the lower insertion groove and the upper insertion groove form a lower insertion protrusion and an upper insertion protrusion on a surface of the gasket,
a contact area between the lower can and the gasket increases by the lower insertion protrusion, and
a contact area between the upper can and the gasket increases by the upper insertion protrusion.

10. The method of claim 8, wherein one of the lower insertion groove and the insertion groove of the upper can has a cross-section having triangular shape that gradually decreases in width toward the bottom.

11. The method of claim 8, wherein, in the preparing, the lower insertion groove or the upper insertion groove is provided in two or more, and
the two or more lower insertion grooves or the two or more upper insertion grooves are connected to each other in a direction in which the lower can and the upper can are clamped.

12. The method of claim 8, wherein, in the preparing, a pressing protrusion pressing the gasket is formed on the lower can below the lower insertion groove, and
in the clamping process, when the lower can and the upper can are clamped, since a lower portion of the gasket is fixed by the pressing protrusion, the gasket is introduced into the lower insertion groove and the upper insertion groove while being expanded in a direction of the upper can and the lower can.
